(19) United States
(12) Patent Application Publication
(10) Pub. No.: US 2010/0228517 A1
(43) Pub. Date: Sep. 9, 2010

(54) LIDAR DEVICES WITH REFLECTIVE OPTICS

(75) Inventors: Charles K. Wike, JR., Sugar Hill, GA (US); Richard M. McEntyre, Atlanta, GA (US); Donald R. Wyman, Flowery Branch, GA (US); Robert P. Burke, Duluth, GA (US)

Correspondence Address: LASERCRAFT, INC., 1450 OAKBROOK DRIVE, SUITE 900, NORCROSS, GA, 30093, US

(73) Assignee: LaserCraft, Inc.

(21) Appl. No.: 12/400,366

(22) Filed: Mar. 9, 2009

(51) Int. Cl. G06F 15/00; G01C 3/08; G01P 3/36

(52) U.S. Cl. 702/149; 356/5.01; 356/28; 702/159

(57) ABSTRACT

Various embodiments of the invention provide a device for detecting the range or the velocity or other state data for a target. According to various embodiments, the device includes a transmitter, a reflective surface, and a receiver. In various embodiments, the transmitter is configured to transmit laser pulses from the device towards a target thereby producing return laser pulses from the target. In particular embodiments, the reflective surface of the device is positioned to receive return laser pulses and is configured to reflect the return laser pulses from the target to a focal point. In various embodiments, the receiver is located at the focal point and is configured to detect the reflected laser pulses to generate a signal used to determine the target's range or velocity. The reflective surface can be used to replace a relatively heavy lens assembly normally mounted in the front of previous devices, thereby improving the balance of the device or reducing its weight.

### BACKGROUND OF THE INVENTION

1. Field of the Invention

The disclosed invention generally relates to devices and methods for detecting the range or the velocity of a target. More specifically, devices and methods in accordance with the present invention detect time from transmission to reception of a laser pulse or pulses to determine the velocity or range of the target.

2. Description of the Related Art

Laser speed and range measurement devices are widely used in law enforcement. For instance, law enforcement personnel use such devices to apprehend speeders operating vehicles in excess of the maximum speed limit. These devices are commonly referred to as LIDAR devices (i.e., light detection and ranging devices).

Such devices emit a short pulse of infrared light that is directed in a beam toward a selected target. The light pulse hits the target and is reflected back. A portion of the reflected or scattered light is returned back towards the LIDAR device. The returned light is collected by the device (e.g., at a detector) and converted into an electrical pulse. In addition, many of these devices have an internal clock that counts the time it takes for the light pulse to travel to the target and back and determines a trip time accordingly. A microprocessor, also located in the device, uses the trip time to determine the range to the target. This process is repeated over a short period of time (e.g., multiple samples of the pulse travel time are taken) to calculate the speed of the target.

A typical LIDAR device uses a lens assembly to collimate the light pulse as the pulse is emitted from the device. Likewise, a typical LIDAR device uses a lens assembly (or the same lens assembly) to collect the returned light reflected from the target. In many cases, the device is shaped like a gun with the two lens assemblies located at the end of the gun barrel away from the handle and trigger of the gun. Typical lens assemblies are constructed of multiple pieces of glass and can be relatively heavy. As a result, a majority of the weight of the gun is located at the end of the barrel. This causes the gun to feel unbalanced in a user's hand and the gun can become too heavy to hold after a period of time.

In addition, in many LIDAR devices, the lens assembly size is limited because of the weight of the assembly. Thus, the lens assembly used to collect the returned light reflected from the target is limited in the amount of light the assembly can collect. To compensate, the LIDAR device may require a transmitter, receiver, and microprocessor with greater capabilities and sensitivities and increased expense than what otherwise would be required if the light collection areas could be increased.

Thus a need exists for a LIDAR device that is lighter for greater ease of operation. Moreover, there exists a need for a LIDAR device with more even weight distribution for better balance in the hand, or at least less weight at the front end. In addition, a need exists for a LIDAR device that has an increased light collection area to capture more light from a reflected light pulse, thereby improving the device's affective sensitivity to permit less expensive, less complex components to be used in the device to reduce its cost.

### BRIEF SUMMARY OF THE VARIOUS EMBODIMENTS OF THE INVENTION

The various embodiments of the invention solve one or more of the problems identified above. According to various embodiments of the invention, a LIDAR device is provided for measuring target velocity, or range. Furthermore, the device can measure other parameters such as time-of-travel of a laser pulse from device to target and back, or time difference between successive laser pulses returned from a target, or possibly other target parameters. The device includes a processor, a timer, a transmitter, a reflective surface, and a receiver, all of which are contained within, or attached to, a housing. An operator aims the device by hand toward a target, such as a moving vehicle, and activates a trigger to generate a trigger signal. In response to the trigger signal, the processor generates at least one signal to start the timer. Also in response to the start signal, the transmitter (e.g., a laser diode) generates and transmits at least one laser pulse or pulses. The transmitter is positioned in the housing in alignment with an optical opening in the housing to permit the laser pulse to pass through the wall of the housing toward the target. The laser pulse travels outwardly from the device, travels the distance to the target, and impinges upon the target, thereby producing reflected laser pulses from the target.

The reflective surface is positioned in the housing to be aligned with an optical opening in the housing. The reflective surface is positioned to receive the return laser pulse or pulses from the target through the optical opening. The reflective surface is sufficiently large in size to collect enough light to enable the receiver to detect the return laser pulse or pulses from the target. The reflective surface has a shape that enables the flat, affectively collimated wavefront of the return laser pulse or pulses to be directed to a focal point at which the receiver (e.g., a photodiode) is positioned in the housing. In various embodiments, the reflective surface is concave. For example, in one embodiment, the reflective surface is a segment of a parabola. Furthermore, in various embodiments, the reflective surface is composed of plastic or other rigid, durable, lightweight material with a reflective coating (e.g., aluminum, gold, etc.) formed thereon. The reflective surface may be used in lieu of a lens to focus return laser light, thereby better distributing or reducing the weight of the device. In various embodiments, the reflective surface is mounted in a housing of the device to direct the received laser pulse to an off-axis focal point outside of the collection area of the housing in which the return laser pulse is received. This configuration enables the receiver to be positioned so as not to obstruct the collection area in front of the reflective surface, thereby enabling the reflective surface to focus more of the reflected laser pulse to the receiver. A positioner mounted to the housing may be used to orient the receiver at the reflective surface's focal point. The housing may define an focal portion in which to accommodate the receiver and positioner.

In an alternative embodiment, the LIDAR device comprises a second, separate reflective surface interposed in the optical path from the transmitter to the optical opening from which laser pulse or pulses exits the housing. The transmitter may act as a point source, or approximately so, and the light of laser pulse or pulses generated by it are divergent so that the beam width increases to a degree as the light travels to the reflective surface. The second reflective surface is positioned in the housing to receive the light from the transmitter, and is shaped to collimate the light of the laser pulse or pulses so that its rays travel in parallel with a flat wavefront from the LIDAR device. Thus, in various embodiments, the second reflective surface sends the light out in the same direction as the collection area receives the reflected laser pulses. This collimation attained through the reflective surface enables a laser pulse with greater optical intensity to be directed more precisely to the target, thereby generating a stronger return laser pulse. The second reflective surface can be structured and composed of similar materials as the first reflective surface used in the reception optical path, and can be used to achieve better weight distribution and balance by eliminating a relatively heavy lens positioned in the front of the device.

In various embodiments, the device includes a lens in the transmission optical path. The lens is fixed in the housing in an optical opening and is positioned to receive and collimate the laser pulse or pulses generated by the transmitter. The collimated laser pulse or pulses exit the device through the lens and travel to the target. The receiver is positioned within the housing to receive and detect the reflected laser pulse or pulses at the focal point of the reflective surface. In response to detection of a laser pulse, the receiver generates a stop signal and is connected to pass the stop signal to the timer. The timer stops in response to receiving the stop signal, and thus holds the elapsed time between activation of the start and stop signals. Based on the elapsed time from activation of the start signal to activation of the stop signal, the timer generates a time signal indicating the time elapsed from transmission to reception of a laser pulse. Also, the receiver is connected to the processor to pass the time signal indicating reception of the return laser pulse to the processor. In response to the receiver signal, the processor reads the time signal from the timer and processes the time signal to determine the velocity or the range or other parameter indicative of the target's state. The processor requires at least one laser pulse to determine range. In addition, the processor can use multiple laser pulses to determine an average range or the velocity.

Depending upon the embodiment and the required degree of accuracy, the processor can be an element such as a microprocessor, microcontroller, field programmable gate array (FPGA), or other programmed computational device.

The timer can be implemented as a time-to-analog converter (TAC) circuit. The processor can be configured to generate a start signal to start or “fire” the TAC circuit to begin ramping up its output voltage at a fixed rate. In response to the stop signal from the receiver indicating arrival of a return laser pulse, the receiver generates a stop signal to stop the TAC circuit. The resulting voltage stored by the TAC at the time it is stopped by the receiver is proportional to the elapsed time from transmission to reception of a laser pulse. Hence, the processor can use the captured voltage level from the TAC to determine the elapsed time from transmission to reception of a laser pulse. Using this data indicating the elapsed time, the processor determines the target range or velocity.

In various embodiments, the device also includes a heads-up display configured for use by an operator of the device to sight the target. The heads-up display includes a display element positioned to oppose a transparent element of a combiner arranged within the field of view defined in the heads-up display. The processor generates a display signal indicating target range or velocity or other parameter regarding the target, in response to the time signal. The processor outputs the display signal to a display element such as a light-emitting diode (LED), organic light-emitting diode (OLED), or liquid crystal display (LCD) which is arranged to illuminate the transparent element of the combiner within the field of view of the heads-up display. An operator of the device can therefore view the target while simultaneously viewing the target's range or velocity or other state parameter within one field of view, thus providing greater ease of operation of the device.

In another embodiment, a single reflective surface is positioned in the housing relative to the transmitter, receiver and optical opening or openings of the housing so as to be common to both the transmission and reception paths of the laser pulse or pulse train. Thus, a laser pulse or pulse train from the transmitter is reflected and collimated by the reflective surface, and is directed through an optical opening in the housing to the target. The return laser pulse or pulses is received through an optical opening in the housing, and impinges upon the same reflective surface which is shaped to focus the return laser pulse or pulses to a focal point at which the receiver is positioned within the housing. Thus, the reflective surface serves to both collimate transmitted laser pulses and focus received laser pulses, greatly simplifying device configuration and achieving economization in the materials used to manufacture the device.

According to further embodiments of the invention, a process is provided for measuring the velocity or range, or both, of the target. The process includes the steps of: (a) generating and transmitting laser pulses towards the target, thereby producing return laser pulses from the target; (b) receiving the return laser pulses returned from the target at a reflective surface; (c) reflecting the return laser pulses received at the reflective surface to a focal point; (d) detecting the return laser pulses at the focal point; (e) generating a signal based on the return laser pulses; (f) processing the signal to determine the range or the velocity of the target; and (g) displaying the range or the velocity of the target on a display device. In one embodiment the method further comprises the steps of (h) receiving the transmitted laser pulses at the reflective surface; and (i) collimating the transmitted laser pulses at the reflective surface; and (j) directing the transmitted laser pulses from the reflective surface to the target. In yet another embodiment the method further comprises the steps of (h) receiving the transmitted laser pulses at a second reflective surface; (i) collimating the transmitted laser pulses at the reflective surface; and (j) directed the transmitted laser pulses from the reflective surface to the target.

Other embodiments of the invention and attendant advantages will become apparent from the subsequent specification.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 illustrates a perspective view of a LIDAR device according to an embodiment of the invention.

FIG. 2 illustrates a front view of the LIDAR device shown in FIG. 1.

FIG. 3 illustrates a back view of the LIDAR device shown in FIG. 1.

FIG. 4 illustrates a perspective view of the LIDAR device shown in FIG. 1 without the protective housing.

FIG. 5 illustrates an overhead view of the LIDAR device shown in FIG. 1 without the protective housing.

FIG. 6 illustrates a schematic diagram illustrating an electronic system of an embodiment of the invention.

FIG. 7 illustrates a perspective view of an alternative embodiment of the LIDAR device without the protective housing.

FIG. 8 illustrates a back view of the LIDAR device shown in FIG. 7.

FIG. 9 illustrates a front view of the LIDAR device shown in FIG. 7.

FIG. 10 illustrates a perspective view of an alternative embodiment of the LIDAR device using a single reflective surface for both the transmission and reception of laser pulses generated by the device.

FIG. 11 illustrates a process for detecting the range or the velocity the range of a target according to an embodiment of the invention.

FIG. 12 is a view of a typical scenario of operation of the LIDAR device according to various embodiments.

### DETAILED DESCRIPTION OF VARIOUS EMBODIMENTS OF THE INVENTION

Various embodiments of the invention are described more fully hereinafter with reference to the accompanying drawings, in which some, but not all embodiments of the invention are shown in the figures. Indeed, these inventions may be embodied in many different forms and should not be construed as limited to the embodiments set forth herein; rather, these embodiments are provided so that this disclosure will satisfy applicable legal requirements.

### General Embodiment

Various embodiments of the invention provide a device for detecting the range or the velocity of a target. According to various embodiments, the device includes a transmitter, a reflective surface, and a receiver. The transmitter is configured to transmit at least one laser pulse from the device toward a target thereby producing a reflected, return laser pulse from the target. The reflective surface of the device is positioned to receive the return laser pulse and is configured to reflect the laser pulse returned from the target to a focal point.

In various embodiments, the receiver is located at the focal point and is configured to detect the return laser pulse. In response to detection of the return laser pulse, the receiver generates at least one signal in response to detection of the laser pulses from the reflective surface. In various embodiments, the device also includes a processor configured to generate a signal indicating the range or the velocity of the target in response to the signal generated by the receiver. As used herein, the term ‘signal’ is used comprehensively to include analog signal or digital data within its meaning, whether in electric, optical or in another physical form.

### An Embodiment of the Device

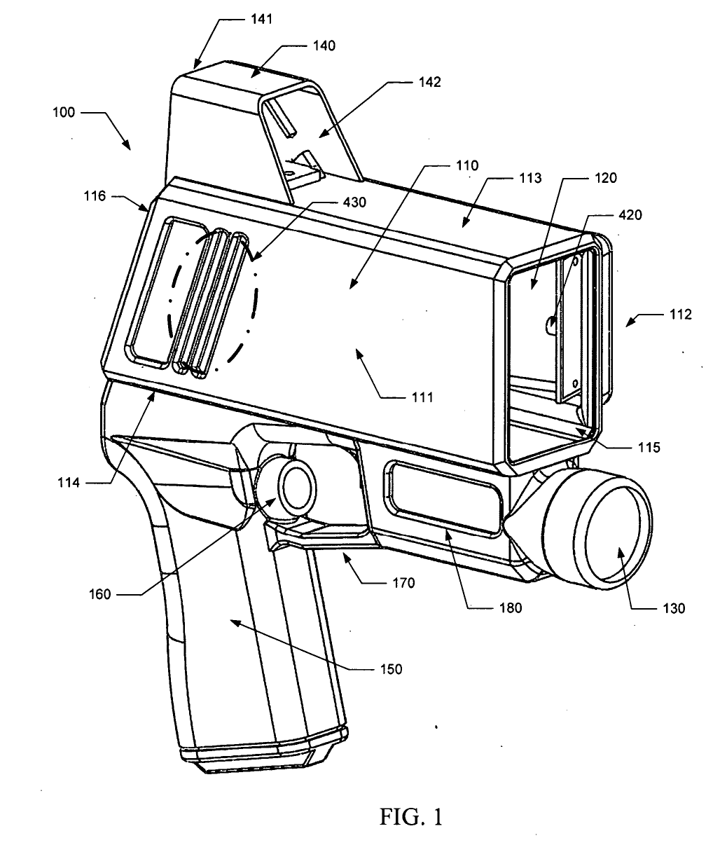

FIG. 1 shows a perspective view of a LIDAR device 100 according to an embodiment of the invention. In the particular embodiment shown in FIG. 1, the device 100 is a hand-held LIDAR gun that is used by an individual for detecting the range or the velocity of a target. For instance, the device shown in FIG. 1 may be used by an individual to detect the speed of a moving vehicle.

In general, the device 100 shown in FIG. 1 includes a protective housing 110, a collection surface 120, a transmitter housing 180, a lens assembly 130, a heads-up display 140, a handle 150, and a trigger 160. Several components of the device 100 (e.g., the protective housing 110, the transmitter housing 180, the heads-up display 140, the handle 150, and the trigger 160) may be constructed of various materials such as a polymer, a metal, or a composite. In various embodiments, a polymer may be preferred to lower the over-all weight and cost of the device 100.

The protective housing 110 may be of various shapes such as a hollow rectangular box, as shown in FIG. 1. The rectangular box includes a first side 111, a second side 112, a top side 113, a bottom side 114, a front side 115, and a back side 116. In addition, the protective housing 110 encloses the reflective optics, the processor and other elements of the device 100. The handle 150 extends at one end of the device 100, below the bottom side 114 of the protective housing 110 and is configured to support the device 100 in the hand of an operator. The trigger 160 protrudes from the front of the handle 150 and is configured to be depressed inwardly towards the handle 150 by the operator to activate the device 100. In various embodiments, the device 100 may also include a trigger guard 170 that is configured as an opening surround the trigger 160 of the device 100 so that the operator's finger may easily fit through the opening to grip the trigger 160.

The transmitter housing 180 extends at the opposite end of the device 100 from the handle 150 below the bottom side 114 of the protective housing 110. In the configuration shown in FIG. 1, the transmitter housing 180 is a hollow rectangular box with a first end of the transmitter housing 180 butting up against the trigger guard 170 of the device 100. In general, the transmitter housing 180 encloses a transmitter that is configured to transmit laser pulses upon activation by the operator depressing the trigger 160. The lens assembly 130 is located at a second end of the transmitter housing 180 opposite the first end. The lens assembly 130, as will be discussed in further detail below, is used to direct the transmitted laser pulses from the transmitter towards the target.

Furthermore, the collection surface 120 is located on the front side 115 of the protective housing 110 above the lens assembly 130. The collection surface 120 is generally transparent, and therefore defines an optical opening in the housing 110, to allow the laser pulses emitted from the device 100 and reflected off of the target back to the device 100 to pass thru the collection surface 120 to a reflective surface located inside the protective housing 110. The collection surface 120 is made of various transparent materials in various embodiments. For example, the collection surface 120 may be constructed of a glass, a composite, or a polymer. Though, in various embodiments, it may be advantageous to use a polymer for purposes of lowering the weight and cost of the device 100.

The device 100 also includes a reflective surface 430 mounted in the protective housing 110 opposite the collection surface 120. The reflective surface 430 is positioned to receive a return laser pulse traveling through the collection surface 120 from a collection area 122 which is the area defined within the housing 110 that is optically in front of the reflective surface 430. The reflective surface 430 is shaped to direct the return laser pulse with planar wavefront to a focal point at which the receiver 420 is positioned. The reflective surface 430 can be configured relative to the direction of incidence of the return laser pulse into the device so that the focal point of the reflective surface 430 is outside of the collection area 122. This enables the receiver 420 to be positioned so that it does not obstruct the return laser pulse entering the collection area 122 of the device through collection surface 120. Therefore, a greater amount of optical energy of the return laser pulse can be directed by the reflective surface 430 to the receiver 420 at its focal point, thereby enabling the receiver 420 to generate a stronger signal in response to receiving the return laser pulse.

The heads-up display 140 of the device shown in FIG. 1 is a hollow rectangular box and is configured to provide an aiming mechanism for the device 100. A heads-up display 140 is typically composed of a transparent display that presents the operator information without requiring the operator to look away from the target. The heads-up display 140 is located on the top surface 113 of the protective housing 110 and is used to house a combiner. In addition, the heads-up display 140 includes a first end 141 and a second end 142. The first end 141 includes an optical opening and is located at the same end of the device 100 the handle 160 is located. The second end 142 is located opposite the first end and also includes an optical opening. The operator of the device 100 looks through the optical opening on the first end 141 and through the combiner and the optical opening in the second end 142 to direct the travel path of the laser pulses transmitted by the device 100 towards the target.

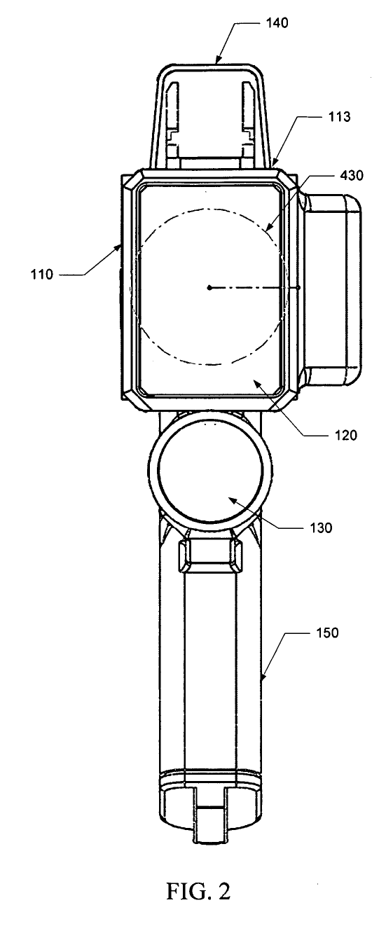

FIG. 2 shows a front view of the LIDAR device shown in FIG. 1 according to one embodiment of the invention. The heads-up display 140 can be seen sitting on the top surface 113 of the protective housing 110, and the collection surface 120 is located above the lens assembly 130. As previously described, the reflective surface 430 is mounted in the protective housing 110 opposite the collection surface 120. Furthermore, the front of the handle 150 extends down from the protective housing 110 behind the lens assembly.

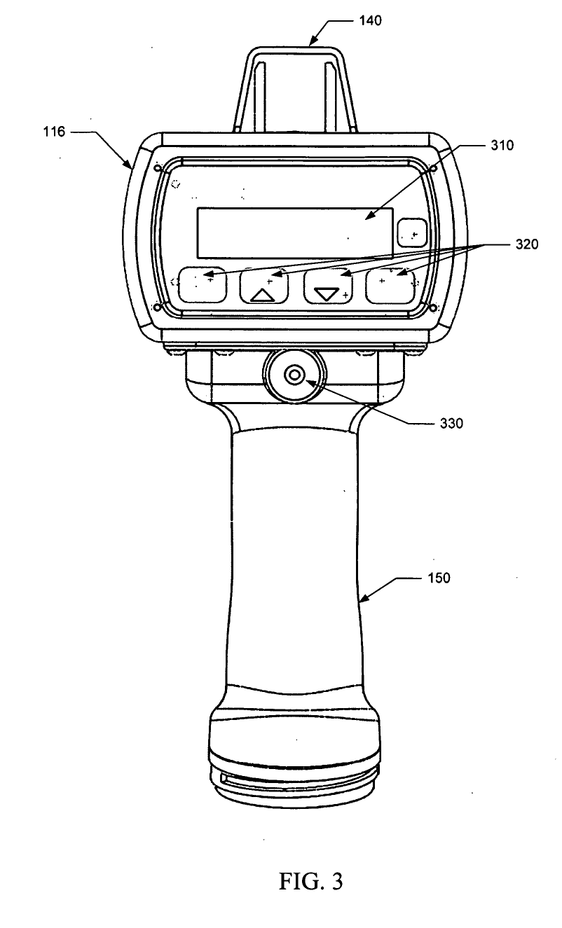

FIG. 3 shows a back view of the LIDAR device shown in FIG. 1 according to one embodiment of the invention. A back panel display screen 310 is located on the back side 116 of the protective housing 110 and is used to display various information related to the operation and status of the device 100. For example, the back panel display screen 310 displays various settings that the operator of the device 100 can set, such as the language in which information is to be displayed on the back panel screen 310 and on the heads-up display 140. For instance, the display screen may provide a listing of different languages and/or countries from which the operator can select a desired language and/or country. Other information may include a listing of different unit to provide measures in, such as M.P.H. or km/hr. The display may be of various types. For example, the display screen 310 can be a digital display or a liquid crystal display (LCD).

In addition, one or more switches 320 (e.g., buttons) may be located on the back side 116 of the protective housing 110 that the operator uses to control and change information on the back panel display screen 310. For instance, two of the switches 320 may display arrows that are used to scroll through menu items on the back panel display screen 310. Other switches may control other aspects of the device 100 such as powering on or off the device 100, changing the brightness of the display screen 310, and adjusting the speaker volume of the device 100. In other embodiments, the device 100 may have a touch screen and therefore not have switches 320 located on the back side.

Furthermore, in various embodiments, the device 100 may also have a one button control 330 that is located near the top of the back side of the handle 150 that operates similar to a joy stick on a computer. The operator manipulates the button 330 with his thumb while holding the device 100 and controls the back panel display screen 310 or heads-up display 140 by rotating the control 330 and depressing the control 330 to make a selection on the screen 310. Thus, the button control 330 can mimic the buttons 320 located below the back panel display screen 310, or in some embodiments, replace the buttons 320. Other embodiments of the device 100 may use a scrolling wheel in a similar fashion as the button control 330.

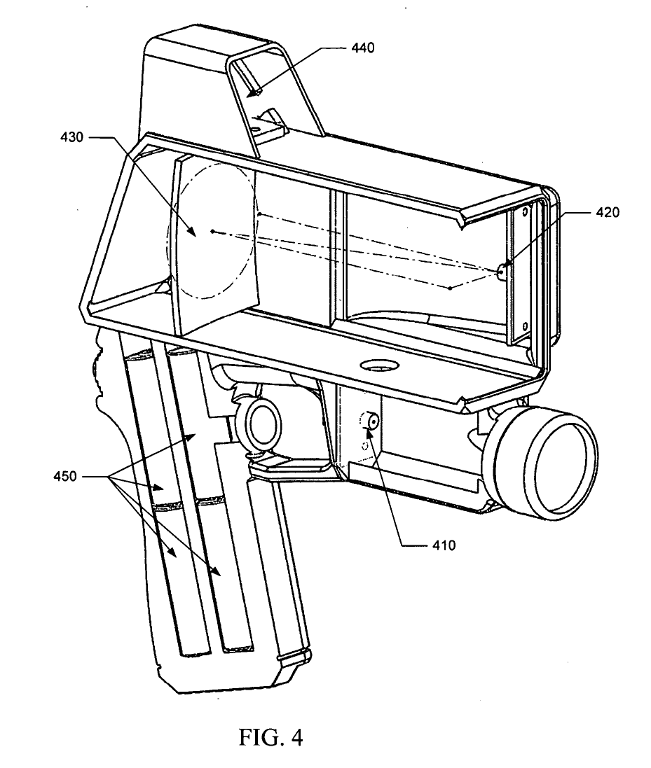

FIG. 4 is a perspective view of the device 100 shown in FIG. 1 with the protective housing 110 removed and certain internal parts of the device 100 illustrated. The particular parts shown in FIG. 4 include a transmitter 410, a receiver 420, a reflective surface 430, a combiner 440, and a power supply 450.

In particular embodiments of the device 100, the combiner 440 is the part of a heads-up display 140 that is located directly in the operator's eyesight and is configured as a surface onto which information is projected so that the operator can view it. For example, the combiner 440 in various embodiments is made of a transparent glass that reflects red light. In various embodiments, the heads-up display 140 also contains a circuit board with an LED that lies parallel to the bottom surface of the display 140 and is configured to illuminate information to display on the combiner 440. For example, the LED displays a red dot on the combiner 440 to help the operator to align the laser of the device 100 with the target. In other embodiments, the LED may display additional information on the combiner 440, such as speed of the target, distance to the target, and battery life. In other embodiments, other displays may be used such as a LCD, organic light-emitting diode (OLED), or computer generated holograph (CGH).

According to various embodiments, the power supply 450 primarily provides power to the electronics of the devices, such as the transmitter 410, the receiver 420, and the processor (not pictured). The power supply 450 of the device depicted in FIG. 4 includes batteries. These batteries can range among various types of batteries such as alkaline, lithium, or rechargeable. In addition, various embodiments of the device 100 may also include a plug-in for a power source external to the device 100. For example, the device 100 may include a plug-in for a cigarette lighter outlet or electrical outlet.

As previously discussed, the transmitter 410 emits laser pulses that travel through the lens assembly 130 and towards the target. In various embodiments, the transmitter 410 is a laser diode. However, in other embodiments, the transmitter 410 may be other types of lasers, such as a photon-emitting semiconductor laser. In general, the transmitter 410 of various embodiments emits pulses at a frequency approximately 200 Hz and in the wavelength range of 800 to 900 nanometers. This is to ensure it is in a range that is safe for human and animal eyes.

The laser pulses emitted by the transmitter 410 are reflected off the target back to the device 100 and pass through the collection surface 120 to a reflective surface 430 of the device 100. As will be described in further detail below, the reflective surface 430 of the device 100 reflects the returned laser pulses to a focal point.

The reflective surface 430 of the device 100 displayed in FIG. 4 is a concave surface. This concave surface may be of various shapes according to various embodiments of the device 100. For instance, in one embodiment, the reflective surface 430 is in the shape of a parabola. In another embodiment, the reflective surface 430 is in the shape of a sphere. Yet in other embodiments, the reflective surface 430 is in the shape of an ellipse or a hyperbola.

In various embodiments, the reflective surface 430 is further defined as a conic section. For example, in the particular embodiment shown in FIG. 4, the shape of the reflective surface 430 of the device 100 is an off-axis section of a parabola. For instance, in one particular embodiment, the reflective surface 430 is a parabolic section (e.g., y=(x̂2/418 mm)) with a focal distance of at 104.50 mm and is off-axis and at a 14-degree angle with respect to the receiver 420. By using an off-axis section of the parabola, the focal point of the reflective surface 430 is positioned offset from the collection surface 120 of the device 100. By having the receiver 420 positioned outside of the collection area 122 in a focal portion 421 of the housing 110, the receiver 420 is not in the direct path of the laser pulses traveling back to the device 100 towards the reflective surface 430. Thus, the receiver 420 does not interfere with the detection of the laser pulses returning from the target.

In this embodiment, the reflective surface 430 is mounted in a slot defined in the housing 110 in a position opposing the collection surface 120 toward the back side of the housing. In an alternative embodiment, an x-y or x-y-z positioner 424 is mounted to the housing 110 and supports and permits positional adjustment of the reflective surface 430 to orient it with respect to the collection surface 110 and a receiver 420.

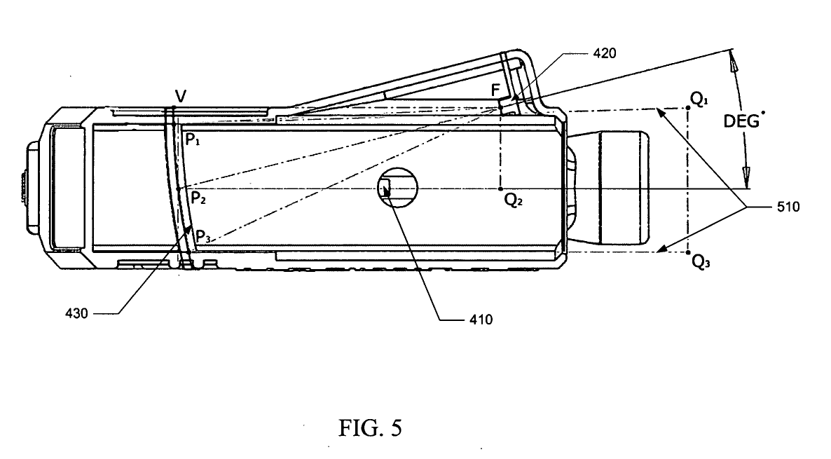

A receiver 420 is located at the focal point to receive and collect the reflected laser pulses. The receiver 420 can be mounted to an x-y or x-y-z axis positioner 425 in order to position the receiver at the focal point of the reflective surface 430. In various embodiments, the receiver 420 may use a silicon avalanche photo detector (APD) followed by an amplifier. To accommodate the receiver 420 at its position outside of the collection area 122 defined within the housing 110, a wall of the housing 110 can be made to protrude outwardly, providing space for mounting the receiver 420, as shown in FIG. 5. The reflective surface 430 in other embodiments may be simply tilt to off-set the focal point however such embodiments may experience aberration.

The reflective path is further shown in FIG. 5, which displays an overhead view of the device 100 with the top surface 113 of the protective housing 110 removed. In particular, FIG. 5 shows an overhead view of the reflective surface 430 as an off-set section of a parabola. Also shown in the figure is the path of the laser pulses 510 traveling back to the device 100. The reflective surface 430 is configured to reflect these laser pulses in a path 520 that concentrates the pulses to a focal point at the receiver 420.

The reflective surface 430 can be made of various materials in embodiments. For instance, the reflective surface 430 may be made of a polymer such as polycarbonate or acrylic. Since there is no concern over the reflective surface 430 having transitive properties in various embodiments, the reflective surface 430 may be made of various non-clear (usually less expensive) materials. In addition, the use of a polymer makes the device 100 lighter in many cases than if other materials are used, such as a glass or a metal.

In various embodiments, the reflective surface 430 may also be coated to make the surface reflective. For instance, in one embodiment, the reflective surface 430 is coated with gold of approximately 40 nm thick. In another embodiment, the reflective surface 430 is coated with aluminum. Such surfaces are used because they are very reflective of infrared radiation.

This reflective coating may be applied to the reflective surface 430 using several techniques such as sputtering or vapor deposition. In addition, one or more protective coatings may be applied over the reflective coating such as anti-scratch coating (e.g., SiO₂ or MgF₂) or an anti-reflection coating (e.g., MgF₂ or fluoropolymers).

Various embodiments of the device 100 provide advantages over a conventional LIDAR device. For example, in various embodiments, the reflective surface 430 is positioned in the back of the device 100, as shown in FIG. 4. This helps to distribute the weight of the device 100 and counter balance the weight of the lens assembly 130 with the weight of the reflective surface 430. As a result, the device 100 of various embodiments is more comfortable to hold for the operator than a conventional LIDAR device which employs lens assemblies at the front of the device to transmit the laser pulses and to collect the reflected laser pulses from the target. For instance, a typical reflective surface 430 in various embodiments of the device 100 may weigh 0.5 ounces (approximately 14 grams), while a lens assembly typically weighs 2.0 ounces (approximately 57 grams). Thus, a conventional LIDAR device that employs a first lens assembly to transmit the laser pulses and a second lens assembly to collect the reflected laser pulses from the target will have a total of 4.0 ounces (approximately 114 grams) weighted at the front of the device. As a result, the conventional device is front heavy and can become uncomfortable for the operator to hold after a period of time.

In addition, in various embodiments, having the reflective surface 430 in the device 100 in the shape of a parabola is advantageous because a parabola will reflect the returned laser pulses to a single focal point. In contrast, lenses used to collect the reflected laser pulses in conventional LIDAR devices are typically circular or spherical in shape. As a result, the lenses do not collect laser pulses and bring them to a focal point due to spherical aberration. Thus, the lens assemblies of many LIDAR devices are usually composed of two pieces of glass (e.g., two lenses) to try and minimize this problem. This can result in unwanted additional weight to the device.

In addition, the reflective surface 430 of various embodiments of the device 100 provide better collection of the reflected laser pulses than the lens assemblies of many conventional LIDAR devices. This is because the lenses used in a conventional LIDAR device are typically coated with scratch resistance coating and anti-reflective coating which results in loss of light passing through the lens assembly.

Furthermore, various embodiments of the device 100 provide more accurate detection of the reflected laser pulses over a conventional LIDAR device. This is because the surface area used for collecting the reflected laser pulses from the target is much greater in various embodiments of the device 100 than in a conventional LIDAR device. Specifically, using a reflective surface 430 that is in the shape of a segment of a parabola provides more collection surface area in comparison to a lens assembly used in a typical LIDAR device. As a result, the electronics of various embodiments of the device 100 do not have to operate with the more advanced capabilities typically required in conventional LIDAR devices. For example, the device 100 of various embodiments may require a lower power amplifier used in the receiver 420 than required in conventional LIDAR devices.

It should be noted that the device 100 does not necessarily need to be a gun. The device 100 can have other configurations according to other embodiments of the invention. For instance, the device 100 may be rectangular or square shaped and configured to be installed on a vehicle. For example, the device 100 may be installed on the dashboard of a police officer's patrol car and may be activated by controls located on the back of the device 100. In addition, the device 100 of other embodiments may be long and rectangular shaped or cylindrical shaped and adapted to be installed on a weapon barrel or a gun turret and used to detect the range, velocity, bearing or other state parameters of a target.

### Electronic System of the Device

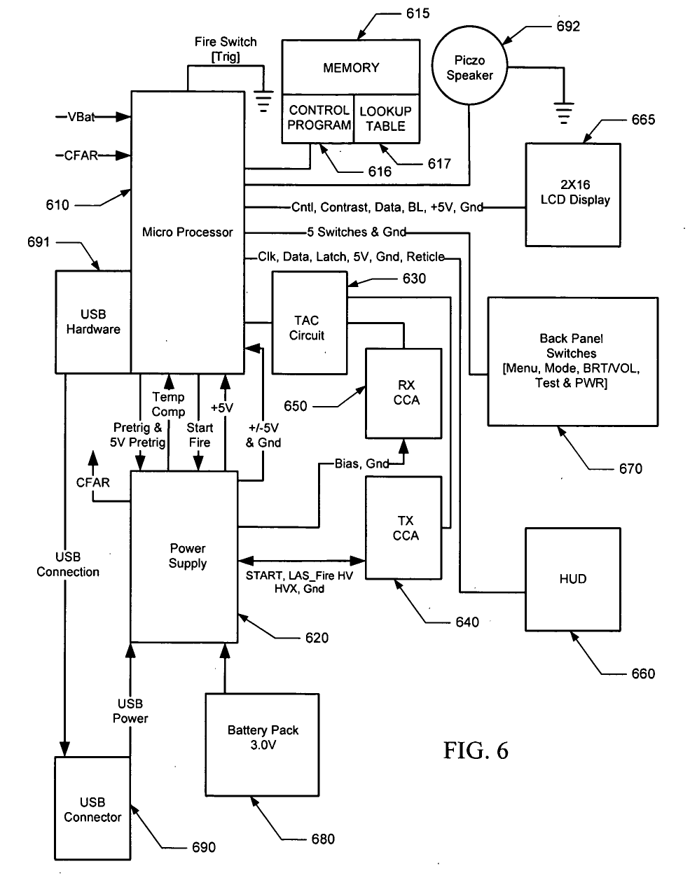

FIG. 6 is a schematic illustrating a system including electronic and photo-electronic elements of various embodiments of the device 100. The elements of the device 100 may be located throughout various parts of the device 100. For example, various components may be located in the handle 150 or in the base of the protective housing 110 of the device 100.

The basic components of the system include a processor 610, a memory 615, a power supply 620, a timer 630, a transmitter 640, a receiver 650, a heads-up display device 660, back-panel display device 665, and back panel switches 670. The heads-up display device 660 is connected to communicate with the processor 610 so that the heads-up display 140 can receive data from the processor 610 to display on the combiner 440 of the display 140.

The processor 610 uses a control program 616 stored in the memory 615 to perform various functions in the operation of the device 100. For instance, the processor 610 is configured to detect the operator's triggering of the device 100 (e.g., the operator depresses the trigger 160 of the device 100) and to generate a start signal to control the power supply 620 of the device 100 to power the transmitter 410 to emit the laser pulses. The transmitter 640 is configured to generate a signal to instruct the timer (e.g., a time-to-analog converter (TAC) circuit) 630 to begin measuring elapsed time in response to the transmitter 410 emitting laser pulses towards the target. Furthermore, the processor 610 is adapted to generate a timestamp from an internal clock upon receiving a transmit signal from the timer 630 indicating a pulse has been emitted from the transmitter 640.

The receiver 650 includes a photodiode or charge-coupled amplifier that is configured to detect the returned laser pulses to the device 100 reflected off of the reflective surface 430 of the device 100. In addition, the receiver 650 is adapted to generate a stop signal to instruct the timer 630 to stop measuring the elapsed time starting from generation of the start signal. The timer 630 provides the resulting time signal to the processor 610. Based on the time signal, the processor 610 generates a signal indicating the range or the velocity of the target.

More specifically, the processor 610 can be programmed to calculate the target range as follows:

Target Range =(Speed of Light)×(elapsed Time from Transmission to reception of Laser Pulse)

Thus, the processor 610 can be programmed to convert the time signal received from the timer 630 into units of seconds, and then divide the speed of light by the elapsed time from transmission to reception of a laser pulse from the target based on the elapsed time signal from the timer 630. Conversion of the time signal into seconds can be done by the processor 610 using a programmed conversion function or a look-up table 617 stored in the memory 615 of the device 100. Alternatively, in embodiments in which the timer 630 generates an analog time signal, such as in the case in which it is implemented as a TAC circuit, the processor 610 can be programmed to read or sample the analog time signal and convert it into digital data, and use the digital data to access to a look-up table that maps the digital data to range data in desired units. Alternatively, in other embodiments, the processor 610 can be programmed with a function to convert the digital data into range data. The precision of range measurement depends upon the application to which the device is applied. In range and velocity measurements used in law enforcement applications, the accuracy of the velocity measurement must be to one-tenth (0.1) miles per hour, and this requires the processor 610 and timer 630 to be accurate to within one nanosecond seconds.

The processor 610 can be programmed to calculate target velocity as follows:

Target Velocity=(Target Range 2−Target Range 1)/(Time of Transmission of Laser Pulse 2−Time of Transmission of Laser Pulse 1)

Thus, the processor 610 calculates the target velocity by subtracting the range data generated from respective laser pulses to produce a range difference, and dividing the range difference by the difference in time between the pulses generating the range data.

The processor 610 is further programmed in some embodiments to calculate average range or target velocity using multiple laser pulses and computations. Averaging can be used to improve accuracy of range of velocity data generated by the processor 610 by smoothing aberrations in measurements that may be generated by anomalous reflections, atmospheric conditions, area of incidence of the laser pulse on the target, and possibly other factors.

Furthermore, in various embodiments, the processor 610 is adapted to transmit the speed information to the back panel display electronics 665 or to the heads-up display electronics 660 so that the information can be displayed on the screen 310 or heads-up display 140.

Additional components of the system may include, according to various embodiments, a battery pack 680, a USB connector 690, USB hardware 691, and a speaker 692. The battery pack 680 provides an energy source to the power supply 620. Other embodiments may also include a plug-in for a power source external to the device. In addition, the system may include USB hardware 691 and a USB connector 690 so that the device 100 can be connected to another device such as a computer to download range, velocity, time or other data. Furthermore, various embodiments of the device 100 may have audible capabilities and include a speaker 692 that is in communication with the processor 610 and adapted to produce sounds as instructed by the processor 610.

### An Alternative Embodiment of the Device

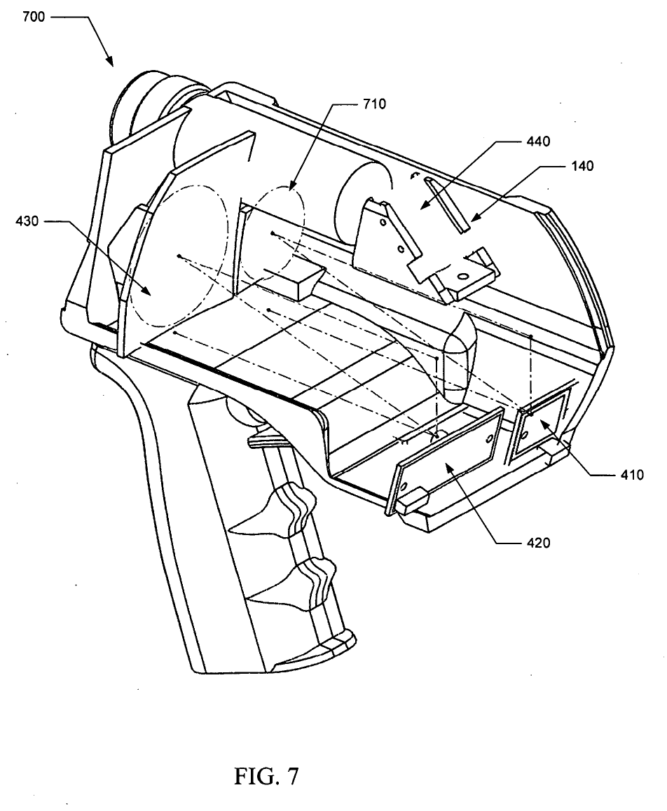

FIG. 7 shows a perspective view of a LIDAR device 700 with the protective housing 110 removed according to an alternative embodiment of the invention. This particular embodiment of the device 700 makes use of two reflective surfaces. The first reflective surface 430 is similar to the reflective surface of the device 100 discussed above and reflects the returned laser pulses to a focal point at the receiver 420 of the device 700. The second reflective surface 710 is adapted to reflect the laser pulses emitted from the transmitter 410 and direct the pulses towards the target. Thus, this embodiment of the device 700 does not use any lens assemblies. As a result, the weight of this device is very light in comparison to the weight of conventional LIDAR devices that utilize lenses.

The embodiment may also include a barrier (not pictured) that is located between the two reflective surfaces 430, 710 and runs down the length of the protective housing 110. For instance, this barrier may be a flat piece that is only a few millimeters thick and is primarily adapted to keep the reflected light pulses from each reflective surface 430, 710 separated from each other. Thus, the barrier eliminates the two sets of pulses from interfering with each other and producing scatter within the protective housing 110 of the device 700. The barrier may be constructed of various materials, for example, it is advantageously constructed of a polymer to minimize the weight of the device 700.

In addition, various electronic or photo-electric components of the device 700 may be placed on the barrier in various embodiments (e.g., the barrier can serve as a vertical circuit board). This helps to maximize the use of space inside of the protective housing 110 of the device 700 and to reduce the size of the device 700.

Furthermore, the device 700 depicted in FIG. 7 includes an alternative embodiment of the heads-up display 140. In this embodiment, the heads-up display is located within the protective housing 110 of the device 700. Such an embodiment helps to further minimize the overall size of the device 700. In addition, other components may be placed on the top of the device 700 such as a camera. This feature can be useful, for example, in enabling law enforcement personnel to obtain video evidence of a speeding or other violation.

Specifically, the heads-up display 140 of the embodiment shown in FIG. 7 is located above the reflective surface 710 for the transmitter 410. This is because the reflective surface 710 for the transmitter 420 in various embodiments of the device 700 has a smaller surface area than the reflective surface 430 for the receiver 420. This is because the surface area of this reflective surface 710 is not as important to device operation and the smaller surface area is sufficient to reflect the transmitted laser pulses toward the target. Thus, by reducing the size of this reflective surface 710 in the device 700, the heads-up display 140 can be placed within the protective housing 110 of the device 700. In this particular embodiment, the combiner 440 of the heads-up display 140 is placed near the front of the device 700 and away from the reflective surface 710. However, the combiner 440 can be placed at different distances along the heads-up display 140 in other embodiments.

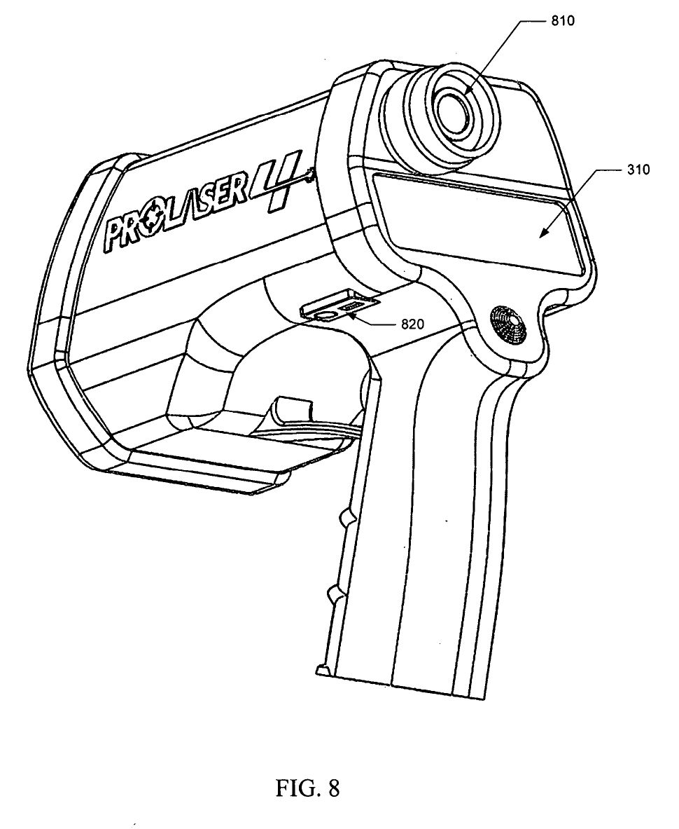

FIG. 8 shows a rear view of the device 700 depicted in FIG. 7. The device 700 has a rear panel display screen 310 similar to the device 100 discussed above. In addition, the rear panel of the device 700 has an eye piece 810 located in the upper left corner of the panel that the operator looks through to use the heads-up display 140. The eye piece 810 may be constructed of various materials, such as a soft rubber material, so that it is comfortable for the operator to look through. Furthermore, the rear of the device 700 (or in proximity to the rear of the device 700) may have additional components such as switches (not pictured) or an I/O port 820 so that the device 700 may be connected to another device such as a computer to download or upload information.

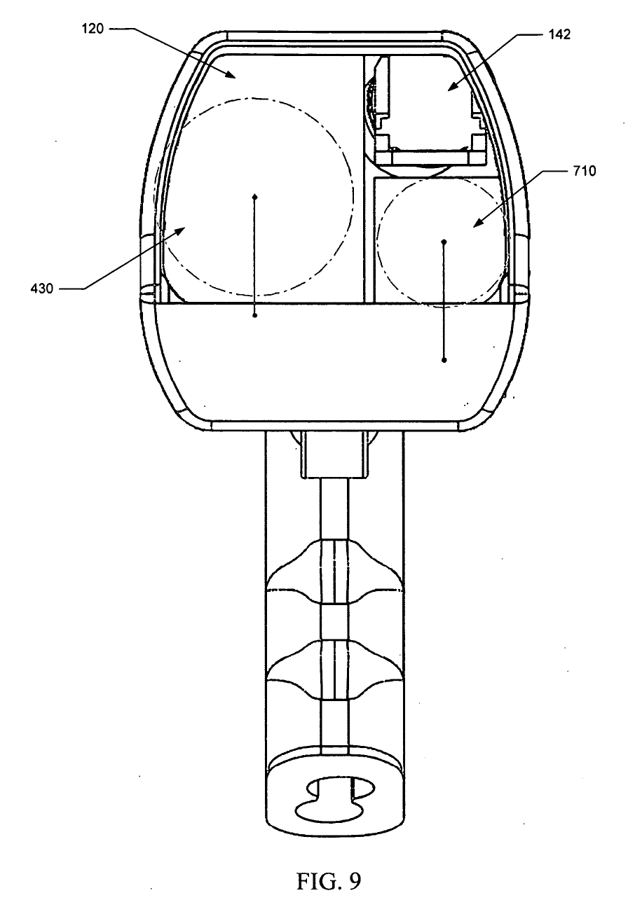

FIG. 9 shows a front view of the device 700 depicted in FIG. 7. The collection surface 120 of this particular embodiment of the device 700 is large enough so that the laser pulses emitted from the transmitter 410 can be reflected from the reflective surface 710 and pass through the collection surface 120 to travel to the target. In addition, the collection surface 120 is large enough so that the returned laser pulses reflected back from the target can pass through the collection surface 120 to the reflective surface 430 inside the protective housing 110, from which the pulses are reflected to the receiver 420. Furthermore, the second end 142 of the heads-up display 140 is located in the upper right corner of the front of the device 700.

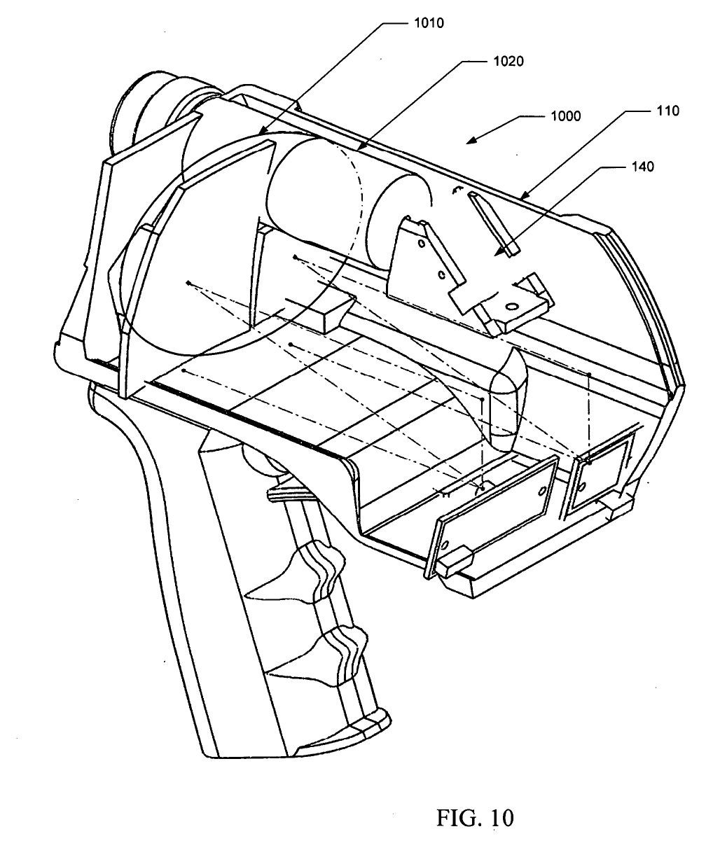

FIG. 10 shows a perspective view of a LIDAR device 1000 with the protective housing 110 removed according to a further alternative embodiment of the invention. This particular embodiment of the device 1000 makes use of one reflective surface 1010 that is adapted to be used to reflect both emitted and received laser pulses. In the particular embodiment shown in FIG. 10, the reflective surface 1010 has a cut-out 1020 so that the heads-up display 140 can fit inside the protective housing 110.

### Operation of the Device

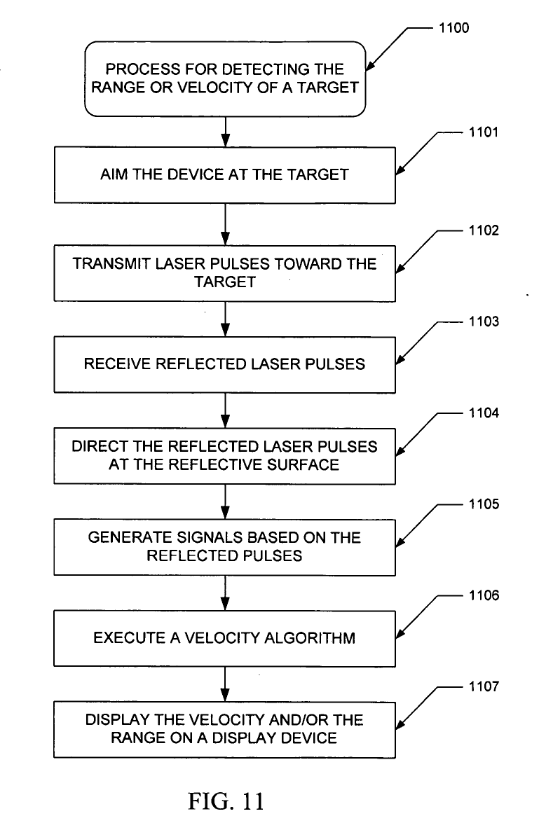

An exemplary process 1100 to operate the device 100 using a reflective surface 430 to measure the range or the velocity of a moving target according to an embodiment is shown in FIG. 11. The process 1100 begins by aiming the device 100 that uses a reflective surface 430 toward the target, shown as Step 1101. In various embodiments, the reflective surface 430 is housed inside the protective housing 110 of the device 100 and is a concave surface. The operator of the device 100 aims the device by observing the target through the heads-up display 140 on the device 100. In various embodiments, the heads-up display 140 displays a red dot on the combiner 440 of the display 140 and the operator lines up the red dot on the moving target and moves the device 100 along with the target by keeping the red dot on the target.

With the target sighted in the heads-up display 140, the operator depresses the trigger 160 of the device 100 to engage the transmitter 410 to transmit laser pulses towards the target, shown as Step 1102. The transmitted laser pulses pass through the lens assembly 130 of the device 100 (or in alternative embodiment, reflect off of a reflective surface 710 in the device 700 and pass through the collection surface 120 of the device 700) and reflect off of the target thereby producing reflected laser pulses from the target.

The reflected laser pulses travel back to the device 100 whereupon the pulses pass through the collection surface 120 of the device 100 and are received at the reflective surface 430 located in the protective housing 110 of the device 100, shown as Step 1103. In Step 1104, the reflective surface 430 directs the reflected laser pulses to a focal point where a receiver 420 is located to detect the reflected laser pulses.

In Step 1105 of the process 1100, the reflected laser pulses are used to generate signals. For instance, the generated signals may be used to determine the elapsed time between transmission of the laser pulses from the transmitter 410 and reception of the reflected laser pulses by the receiver 420. As explained, the processor 610 of the device 100 is configured to generate range data indicating the target's range from the device 100 based on the elapsed time from transmission to reception of a laser pulse from the target as determined by the processor 610 or the timer 630 or both. As previously indicated, in various embodiments, steps of this process 1100 are repeated (e.g., the transmitter transmits a laser pulse towards the target, the return laser pulse is detected, and the detected laser pulse is used to generate an elapsed time) so that the processor 610 can use this data to calculate the velocity of the target. More specifically, in the case of determining target velocity, the processor 610 determines the difference between two range data measurements and divides by the time difference of the two times at which the laser pulses for the two range data were transmitted as determined by the timestamps maintained by the processor 610. The result can be scaled to desired units by a look-up table accessible to the processor 610. Thus, the processor 610 of the device 100 executes a velocity algorithm to determine data indicating the target velocity, shown as Step 1106. Moreover, the processor 610 can use the data generated by multiple laser pulses to calculate average range or velocity values for enhanced accuracy.

Once the velocity or the range have been determined, in Step 1107, the processor 610 sends the determined range or velocity data, or both, to display on a display component. For example, the determined range or velocity data are displayed on the back panel display electronics 665 or the heads-up display electronics 660 of the device 100. The operator of the device 100 can then read the velocity or the range data from the display.

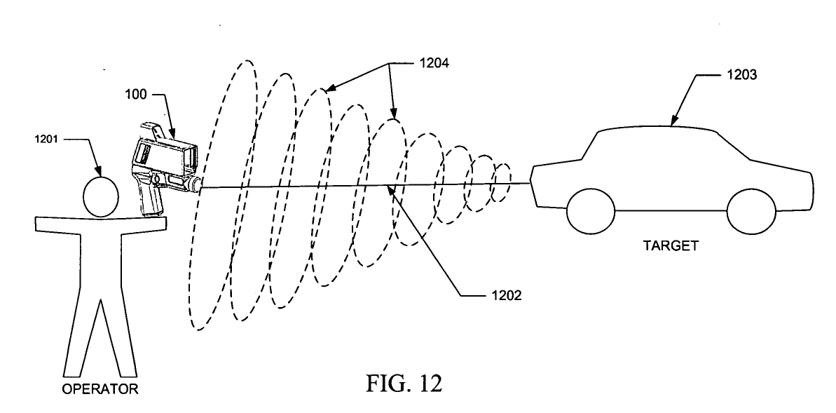

FIG. 12 displays an operator 1201 using the device as described above. In the figure, the operator 120 aims the device 100 at the target 1203 (e.g., a moving vehicle) and fires the device 100 to transmit laser pulses 1202 towards the target. The transmitted laser pulses 1202 reflect off of the target 1203 back towards the device 100. As described above the reflected laser pulses 1204 are collected at the reflective surface 430 of the device 100 and directed to a focal point where a receiver 420 is located. In response, the reflected laser pulses are used to generate signals that are used to determine the range or the velocity of the target 1203.

### Conclusion

Although this invention has been described in specific detail with reference to the disclosed embodiments, it will be understood that many variations and modifications may be effected within the spirit and scope of the invention as described in the appended claims.

1. A LIDAR device for measuring a range or a velocity of a target, the device comprising:
a processor configured to generate at least one start signal in response to a trigger signal;
a timer connected to the processor and configured to receive the start signal, the timer measuring elapsed time starting from activation of the start signal;
a transmitter connected to at least one of the processor and timer to receive the start signal, the transmitter configured to transmit at least one laser pulse from the device toward the target in response to the start signal, thereby producing at least one reflected laser pulse from the target;
a reflective surface configured for directing the reflected laser pulse returned from the target to a focal point;
a receiver configured to detect the reflected laser pulses at the focal point and configured to generate at least stop signal in response to receiving the reflected laser pulse;
the timer connected to receive the stop signal, the timer generating a time signal indicating elapsed time from transmission to reception of a laser pulse based on the start signal and the stop signal; and
the processor connected to receive the time signal from the timer, the processor further configured to process the time signal to generate a range signal or a velocity signal indicating the range or the velocity of the target.

2. The LIDAR device of claim 1, wherein the reflective surface has a concave shape.

3. The LIDAR device of claim 2, wherein the reflective surface comprises a segment of a parabola.

4. The LIDAR device of claim 1 further comprising:
a housing defining a collection area optically positioned in advance of the reflective surface and configured to receive the reflected laser pulse through an optical opening defined in the housing, the reflective surface mounted in the housing in an orientation to direct the reflected laser pulse received in the collection area through the optical opening to the focal point at a position outside of the collection area so that the receiver does not obstruct the reflected laser pulse in the collection area of the housing.

5. The LIDAR device of claim 4 wherein the receiver is mounted in a focal portion of the housing outside of the collection area defined therein.

6. The LIDAR device of claim 5 further comprising:
a positioner mounted to the housing in the focal portion thereof, wherein the receiver is mounted in the positioner, the positioner operable to adjust the position of the receiver at the focal point of the reflective surface.

7. The LIDAR device of claim 1 further comprising a lens, wherein the transmitter is configured for transmitting the laser pulse through the lens, and the transmitter generates the laser pulse as divergent light so that its beam width expands as the divergent light travels toward the lens, and the lens is further configured to receive and collimate the divergent light into plane waves directed toward the target.

8. The LIDAR device of claim 1 further comprising:
a lens and at least one housing, wherein the transmitter is configured for transmitting the laser pulse through the lens, and the lens is configured for directing the laser pulses toward the target and is mounted in the housing in a position in proximity to the front of the device, and the reflective surface is mounted in the housing in proximity to the back of the device so that the weight of the reflective surface counterbalances the weight of the lens.

9. The LIDAR device of claim 1 wherein the display device comprises a heads-up display with a transparent surface for displaying the range or the velocity of the target within a field of view of the heads-up display used to sight the target and the heads-up display is contained within a housing of the device.

10. The LIDAR device of claim 1 further comprising:
a second reflective surface, wherein the transmitter is configured for transmitting the laser pulse towards the second reflective surface and the second reflective surface is configured for directing the laser pulses towards the target.

11. The LIDAR device of claim 1, wherein the transmitter is configured for transmitting the laser pulse toward the reflective surface and the reflective surface directs the laser pulses towards the target.

12. The LIDAR device of claim 1, wherein the reflective surface is plastic.

13. A LIDAR device for measuring a range or a velocity of a target, the device comprising:
a protective housing having at least one wall and having an focal portion extending outwardly from the wall;
a handle attached to and extending downwardly from the protective housing;
a trigger mounted in the handle in a portion thereof in proximity to the protective housing;
a transmitter housing mounted on the bottom side of the protective housing forward of the trigger;
a processor mounted in the device and connected to the trigger, the processor configured to generate at least one start signal in response to activation of the trigger by an operator of the device;
a timer mounted in the device and configured to receive the start signal from the processor, the timer configured to begin measuring elapsed time in response to the start signal;
a transmitter mounted in the transmitter housing and connected to at least one of the processor and the timer, the transmitter configured for generating and transmitting at least one laser pulse from the device toward the target in response to the start signal, thereby producing a reflected laser pulse from the target;
a reflective surface mounted in the protective housing opposite an optical opening in the front end thereof, the reflective surface and the wall of the protective housing defining a collection area for the reflected laser pulse, the reflective surface configured for receiving and directing the one or more reflected laser pulses returned from the target to a focal point positioned outside of the collection area in the focal portion defined by the protective housing;
a receiver positioned at the focal point of the reflective surface outside of the collection area defined in the housing so as not to obstruct the reflected laser pulse, the receiver configured to generate at least one stop signal in response to receiving the reflected laser pulse;
the timer further connected to receive the stop signal from the receiver, the timer configured to generate a time signal indicating the elapsed time from activation of the start signal to activation of the stop signal; and
the processor configured for receiving the time signal and processing the time signal to generate a range signal or a velocity signal indicating the range or the velocity of the target.

14. The LIDAR device of claim 13, wherein the reflective surface has a concave shape.

15. The LIDAR device of claim 13, wherein the reflective surface comprises a segment of a parabola.

16. The LIDAR device of claim 13, further comprising:
a positioner mounted to the housing in the focal portion thereof, wherein the receiver is mounted in the positioner to allow adjustment of the position of the receiver to the focal point of the reflective surface.

17. The LIDAR device of claim 13, further comprising a lens configured to receive the laser pulse from the transmitter and to direct the laser pulse toward the target, wherein the lens is positioned in proximity to the front of the device and the reflective surface is positioned in proximity to the back of the device so that their weight counterbalances relative to the handle.

18. The LIDAR device of claim 13, further comprising:
a second reflective surface, wherein the transmitter is configured to transmit the laser pulse toward the second reflective surface and the second reflective surface is configured for directed the laser pulse toward the target.

19. The LIDAR device of claim 13, wherein the transmitter is configured to transmit the laser pulse toward the reflective surface and the reflective surface directs the laser pulse toward the target.

20. The LIDAR device of claim 13, wherein the reflective surface is plastic.

21. The LIDAR device of claim 13, wherein the transmitter comprises a laser diode.

22. The LIDAR device of claim 13, wherein the receiver comprises an avalanche photodiode.

23. A method for measuring a velocity or a range of a target, the method comprising the steps of:
transmitting laser pulses towards the target thereby producing return laser pulses from the target;
receiving the return laser pulses returned from the target at a reflective surface;
reflecting the return laser pulses received at the reflective surface to a focal point;
detecting the return laser pulses at the focal point;
generating data based on the return laser pulses;
processing the data to determine the velocity or the range of the target; and
displaying the velocity or the range of the target on a display device.

24. The method of claim 23, wherein the provided reflective surface has a concaved shape.

25. The method of claim 24, wherein the provided reflective surface comprises a segment of a parabola.

26. The method of claim 23, wherein the step of transmitting the laser pulses is conducted by transmitting the laser pulses towards a second reflective surface that directs the laser pulses towards the target.

27. The method of claim 23, wherein the step of transmitting the laser pulses is conducted by transmitting the laser pulses towards the reflective surface that directs the laser pulses towards the target.

28. The method of claim 23, further comprising the steps of:
receiving the transmitted laser pulses at the reflective surface; and
collimating the transmitted laser pulses at the reflective surface; and
reflecting the transmitted laser pulses from the reflective surface to the target.

29. The method of claim 23, further comprising the steps of:
receiving the transmitted laser pulses at a second reflective surface;
collimating the transmitted laser pulses at the reflective surface; and
reflecting the transmitted laser pulses from the reflective surface to the target.
